(19) United States
(12) Patent Application Publication
(10) Pub. No.: US 2026/0302903 A1
(43) Pub. Date: Oct. 1, 2026

(54) STATOR AND METHOD FOR PRODUCING STATOR

(71) Applicant: DENSO CORPORATION, Kariya-city (JP)

(72) Inventor: Junpei YAMADA, Kariya City (JP)

(73) Assignee: DENSO CORPORATION, Kariya-city (JP)

(21) Appl. No.: 19/698,963

(22) Filed: Jun. 5, 2026

Related U.S. Application Data
(63) Continuation of application No. 17/880,449, filed on Aug. 3, 2022.

(30) Foreign Application Priority Data
Aug. 3, 2021 (JP) 2021-127814

(51) Int. Cl. H02K 15/0643; H02K 3/28; H02K 15/043; H02K 15/35

(52) U.S. Cl. CPC H02K 15/0643; H02K 3/28; H02K 15/0433; H02K 15/35

(57) ABSTRACT

A stator and a manufacturing method thereof is enabled to easily determine the quality of welding produced between conductors. The stator includes a stator core and a stator winding installed in the stator core. The stator winding is configured by including multiple flat conductor segments in which conductors 34 are coated with insulating films 35, respectively. At a leading end of each of the conductor segment, an exposed portion 33 is formed in which the conductor is exposed. At a coil end section of the stator winding, a pair of exposed portions of different conductor segments are joined together by laser welding. A collective conductor width in a joining direction in which exposed portions join with each other is smaller at a laser irradiation incidence side, which is a side of the exposed portions receiving laser irradiation than that at a side opposite to the laser irradiation incidence side.

### CROSS-REFERENCE TO RELATED APPLICATION

This application is a Continuation application of U.S. patent application Ser. No. 17/880,449, filed on Aug. 3, 2022, which is based on and claims priority to Japanese Patent Application No. 2021-127814, filed on Aug. 3, 2021 in the Japan Patent office, the entire disclosures of which are hereby incorporated by reference herein.

### BACKGROUND

### Technical Field

The present disclosure relates to a stator included in a rotating electric machine and a method for producing the stator.

### Related Art

In a stator included in a rotation electric machine, a stator winding is installed in a stator core. For example, the stator winding is constituted by connecting multiple conductor segments respectively constituted by rectangular conducting wires, to each other.

More specifically, to produce the stator winding, an exposed portion excluding an insulating film is formed initially at a leading end of each of the conductor segments. Then, exposed portions of different conductor segments are joined together and connected to each other by laser welding.

However, with the above-described configuration, that is, when the exposed portions of different conductor segments are connected to each other by laser welding, if welding is not precisely performed, electric conduction through the stator winding is likely to be defective. Such poor welding can generally occur in a situation where a depth of welding in a weld is insufficient. However, it is difficult to confirm the depth of welding in the weld of the conductor segment. That is, a quality of welding is insufficiently confirmed or evaluated based on an appearance of the weld of the conductor segment.

The present disclosure has been made to address and resolve the above-described problems, and it is a primary object to provide a stator and a manufacturing method thereof capable of easily determining a quality of welding in a weld formed between conducting wires.

### SUMMARY

Accordingly, according to one aspect of the present disclosure provides a novel stator that includes a stator core and a stator winding disposed in the stator core. The stator winding is configured by including multiple rectangular conducting wires (e.g., segments). Each of the multiple rectangular conducting wires is constituted by a conductor coated with an insulating film. Each of the multiple rectangular conducting wires has an exposed portion at least at a leading end thereof, in which the conductor is exposed. Exposed portions of different conducting wires are placed parallel to each other contacting each other side by side with end faces being initially placed on a same plane. The exposed portions of different conducting wires are joined together at a point of contact therebetween by laser welding to serve as a coil end section of the stator winding. A collective width of conductors of different conducting wires joined together at the point of contact in a joining direction at which the exposed portions of the different conducting wires are joined is smaller at a laser irradiation incidence position where laser irradiation is incident on the conductors of the different conducting wires than a collective width of the conductors joined together at another position opposite to the laser irradiation incidence position of the conductors.

That is, in a configuration in which the exposed portions of the conductors are joined together by laser welding, a degree of melting of the conductors due to irradiation of a laser is different in the joining portion of the exposed portions between a laser irradiation incidence side and a side opposite to the laser irradiation incidence side. That is, the melting degree is greater on the laser irradiation incidence side. In other words, a non-melted portion in the joining direction in which the exposed portions are joined is narrower at the laser irradiation incidence side and is wider at the side opposite to the laser irradiation incidence side. In such a situation, when the exposed portions are joined, each of the exposed portions can mutually come close to each other in accordance with the degree of melting in the joining portion. In other words, respective side surfaces of the exposed portions, opposite to the joining surface can mutually come close to each other. Further, in view of a difference in degree of melting by a laser between the laser irradiation entry side and the side opposite to the laser irradiation side, the conductor width in the joining direction in which the exposed portions join together varies from the laser irradiation entry side to the side opposite to the laser irradiation entry side. Hence, since a difference in degree of melting in the laser irradiation direction occurs in correlation with a depth of laser welding, the depth of the laser welding can be recognized based on a change in size due to melting of the exposed portions.

In view this, according to a first embodiment of the present disclosure, in a stator winding of a stator having the above-described configuration, exposed portions of conducting wires made of rectangular wires are welded together, and a conductor width of the exposed portions in the joining direction, in which the exposed portions join together is narrower at a side at which laser irradiation is performed (i.e., the laser irradiation incidence side) than the opposite side to the laser irradiation incidence side. In this configuration, when the conductor width of the laser irradiation incidence side is smaller than the conductor width of the side opposite to the laser irradiation incidence side, it can be recognized that each of the exposed portions has melted appropriately. Hence, it is possible to provide a stator produced by adequately using laser welding.

According to another aspect of the present disclosure, a rise made of molten conductor is formed on the laser irradiation incidence side at a joining boundary where the exposed portions are joined together.

Hence, according to a second embodiment of the present disclosure, in addition to a configuration in which the conductor width of the pair of exposed portions joined together is smaller at the laser irradiation incidence side than the conductor width thereof at the side opposite to the laser irradiation incidence side, the rise made of molten conductor is formed on the laser irradiation incidence side. In this configuration, it can be noted that the rise is formed on the laser irradiation incidence side due to melting of the conductors. That is, it can be recognized that as melting of the conductors proceeds at the laser irradiation side, the exposed portions mutually come close to each other, thereby causing melted conductor to protrude. Hence, the rise can be a marker indicating that the exposed portions have properly melted. With this, it is possible to recognize a state of welding based on an appearance thereof.

According to yet another aspect of the present disclosure, the stator winding is disposed in the stator core with the conducting wire being accommodated in a slot of the stator core in a multilayer state in a radial direction.

That is, in general, a conducting wire is accommodated in the slot of the stator core of the stator having the above-described configuration in a multilayer state in the radial direction. Further, a plurality of axial ends configured by connecting the exposed portions of the conducting wires at the coil end section line up in both circumferential and radial directions. In such a configuration, each of the axial ends is separated from each other at the coil end section. However, a separation distance between the axial ends in the radial direction is less than a separation distance therebetween in the circumferential direction.

In view of this, according to a third embodiment of the present disclosure, the collective conductor width of the axial ends of the exposed portions is smaller at the laser irradiation incidence side than the conductor width thereof at the side opposite to the laser irradiation incidence side. Hence, when compared to a configuration in which the collective conductor width at the laser irradiation incidence side is the same as the conductor width at the side opposite to the laser irradiation incidence side, the separation distance (i.e., insulation distance) between the axial ends can be increased. In particular, in a configuration in which the exposed portions are superimposed in the radial direction and joined together by laser welding, the axial ends come closer to each other than in a configuration in which the exposed portions are superimposed in the circumferential direction. However, even with such a configuration, the axial ends can be appropriately insulated from each other.

According to a fourth embodiment of the present disclosure, the coil end section is configured by connecting a leading end of the conducting wire extended in a first circumferential direction and a leading end of the other conducting wire extended in a second circumferential direction opposite to the first circumferential direction to each other at a position axially outside of the stator core. The exposed portions are respectively formed at the leading ends of the conducting wires extended in opposite circumferential directions to each other. The exposed portions of the conducting wires are joined together by laser welding. A width of a first portion of the conductors joined together in a joining direction, in which the exposed portions are joined together, which receive incidence of laser irradiation is less than a second portion of the conductors joined together. The second portion is opposite to the first portion.

That is, the configuration is one in which each of the exposed portions is formed at the leading end (i.e., circumferential leading end) of a conducting wire extended from the opposite side to each other in the circumferential direction, and circumferential tips are connected by laser welding. It is considered that it will become more difficult to confirm the welding depth when compared to a configuration, in which a leading end including an exposed portion in each of conducting wires extended in the axial direction and the leading ends extended in the axial direction (i.e., axial tips) are joined together by laser welding. In view of this, according to the fourth aspect of the present disclosure, since the conductor width of the laser irradiation incidence side is smaller than the conductor width of the opposite side to the laser irradiation incidence side after laser welding, the welding depth can be appropriately confirmed while improving the quality of the stator winding.

Another aspect of the present disclosure provides a novel resin sealer made of insulating resin disposed covering coil end sections including the exposed portions in the axial direction.

Hence, according to a fifth embodiment of the present disclosure, the coil end section is provided with a resin sealer made of insulating resin within a region involving exposed portions in the axial direction. Hence, favorable insulation performance can be maintained between the conducting wires.

According to another aspect of the present disclosure, the stator winding is disposed in the stator core with conducting wire being accommodated in the slot in a multilayer state in a radial direction. Multiple axial ends are configured by connecting the exposed portions to each other per axial end and are arranged at the coil end section while being aligned in both radial and circumferential directions. The resin sealer collectively seals the multiple axial ends. The resin sealer has an annular shape extended along an axial end face of the stator core. The resin sealer has a radially inner circumferential surface and a radially outer circumferential surface each inclined to the axial direction to approach the axis at a position axially outside of the stator core.

Hence, according to a sixth embodiment of the present disclosure, in a configuration in which multiple axial ends configured by connecting multiple pairs of exposed portions of conductor wires to each other are arranged in the coil end section and line up in both the radial and circumferential directions, since the multiple axial ends are sealed together by a resin sealer having a circular shape along the axial end face of the stator core, the resin sealer can effectively seal the multiple axial ends at the coil end section. Further, in exposed portions of the radial innermost axial end and the radially outermost axial end among the multiple axial ends arranged in the radial direction, surfaces respectively facing the inner peripheral side surface and the outer peripheral side surface of the resin sealer are inclined to the axial direction in the same way as the inner and outer peripheral side surfaces. With this, a thickness of an insulating resin filled between each of the exposed portions and the resin sealer can be uniformed at the inner and outer peripheral sides of the resin sealer. Hence, even if there is a difference in thermal expansion between the conductors and the insulating resin in accordance with a difference in linear expansion coefficient, a load acting on each of the exposed portions can be equalized. With this, the stator winding can be protected.

According to another aspect of the present disclosure, the exposed portions joined together by welding have a welded portion made of molten conductor and a non-welded portion in which unmelted conductors face each other therebetween. The non-welded portion of the exposed portions are in contact with each other.

That is, in a configuration in which each of the exposed portions is sealed with an insulating resin at the coil end section, if the insulating resin enters a gap between the pair of exposed portions joined together by welding, due to a difference in linear expansion coefficient between the conductors and the insulating resin, shear is likely to occur in a weld generated between the exposed portions. In view of this, according to the seventh aspect of the present disclosure, since non-welded portions of the pair of exposed portions joined together by welding are brought into contact with each other, shear of the weld due to a difference in linear expansion coefficient between the conductors and the insulating resin can be reduced or suppressed.

Another aspect of the present disclosure provides a novel method for producing a stator that includes: a stator core and a stator winding disposed in the stator core. The stator winding is configured by including multiple rectangular conducting wires. Each of the multiple rectangular conducting wires is constituted by a conductor coated with an insulating film. The conducting wire has an exposed portion at a leading end thereof, in which the conductor is exposed. Exposed portions of the different conductors are connected by laser welding to serve as a coil end section of the stator winding. The method comprises the steps of: attaching the conducting wires to the stator core as an attaching step; welding the exposed portions of the different conducting wires by irradiation of laser in the coil end section as a welding step performed after the step of attaching; and causing a collective width in the joining direction of the conductors of exposed portions joined together by irradiation of laser at a first position initially receiving irradiation of laser to be less than a collective width in the joining direction of the conductors contacted at a second position opposite to the first position.

Hence, according to the eight aspect of the present disclosure, the joining portion between the exposed portions pressure-contacted each other is irradiated with a laser during a welding process to manufacture a stator, and a collective width of the conductors in the joying direction, in which the exposed portions join together is made smaller at a laser irradiation incidence side, which is a side receiving an entry of laser irradiation than a collective width of the conductors at a side opposite to the laser irradiation incidence side. Then, by considering that a degree of melting due to the laser is different between the laser irradiation incidence side and the opposite side thereto along the joining portion between the exposed portions, and the melting degree is larger at the laser irradiation incidence side, and a difference in melting degree in the laser irradiation direction occurs in correlation with a depth of laser welding, the depth of the laser welding can be recognized by a change in width due to melting of the exposed portions. That is, it can be recognized that when the conductor width of the laser irradiation incidence side is smaller than the conductor width of the opposite side, each of exposed portions has appropriately melted. With this, it is possible to provide a stator that has appropriately undergone laser welding.

According to another aspect of the present disclosure, the method comprises the step of inspecting a welded portion between the exposed portions joined together by irradiation of laser by comparing the conductor width of the first portion receiving the laser irradiation and the conductor width of the second position after the step of welding performed in the welding step.

According to the ninth aspect of the present disclosure, based on a change in difference in conductor width between the laser irradiation incidence side and the side opposite to the laser irradiation incidence side in correlation with the welding depth, quality of the weld can be appropriately controlled.

### BRIEF DESCRIPTION OF THE DRAWINGS

A more complete appreciation of the present disclosure and many of the attendant advantages of the present disclosure will be more readily obtained as substantially the same becomes better understood by reference to the following detailed description when considered in connection with the accompanying drawings, wherein:

FIG. 1 is a perspective view illustrating an exemplary stator according to a first embodiment of the present disclosure;

FIG. 2 is a front view illustrating the stator of FIG. 1;

FIG. 3 is a perspective view illustrating a stator winding and a part of the stator core according to the first embodiment of the present disclosure;

FIG. 4 is a diagram illustrating some conductor segments accommodated in a slot according to the first embodiment of the present disclosure;

FIG. 5 is a perspective view illustrating multiple conductor segments connected to each other according to the first embodiment of the present disclosure;

FIG. 6 is an enlarged front view illustrating a configuration of an exposed portion of the conductor segment and the vicinity thereof according to the first embodiment of the present disclosure;

FIG. 7 is a cross-sectional view illustrating the conductor segment of FIG. 6 along a line 7-7 shown in FIG. 6;

FIG. 8 is a diagram illustrating multiple axial ends (i.e., ends in an axial direction) arranged in the radial direction according to the first embodiment of the present disclosure;

FIG. 9 is a perspective view illustrating the stator according to the first embodiment of the present disclosure;

FIG. 10 is a diagram illustrating multiple axial ends aligned in the radial direction and a resin sealer according to the first embodiment of the present disclosure;

FIGS. 11A, 11B, and 11C are diagrams illustrating a welding process according to the first embodiment of the present disclosure;

FIG. 12 is a perspective view illustrating an exemplary stator according to a second embodiment of the present disclosure;

FIG. 13 is a front view illustrating the stator of FIG. 12;

FIG. 14 is a perspective view illustrating multiple conductor segments connected to each other according to the second embodiment of the present disclosure;

FIGS. 15A and 15B are diagrams illustrating a configuration of the conductor segments connected to each other according to the second embodiment of the present disclosure; and

FIG. 16 is a cross-sectional view illustrating the conductor segment shown in FIGS. 15A and 15B along a line 16-16 shown in FIG. 15B.

### DETAILED DESCRIPTION

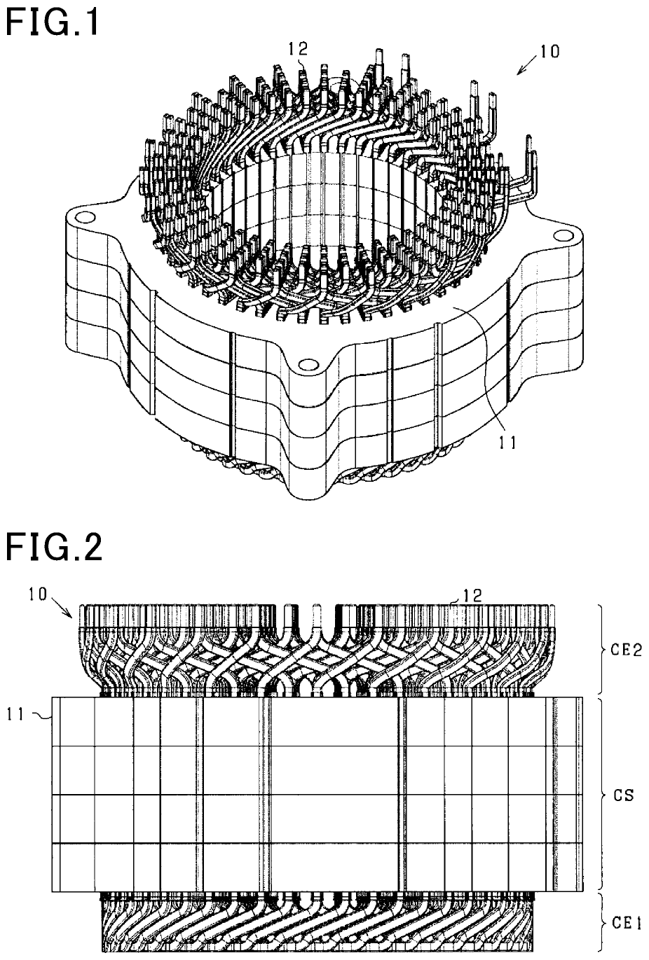

Referring now to the drawings, wherein like reference numerals designate identical or corresponding parts throughout the several views thereof and to FIGS. 1 to 11C, a rotating electric machine according to the first embodiment of the present invention will be described.

In various embodiments and modifications described hereinbelow, the same or equivalent portions are given the same reference numerals, and a portion assigned with the same reference numeral is not described repeatedly while making a reference thereto. In this embodiment, a motor acting as a rotating electric machine is used, for example, as an electric motor for either a vehicle or an aerial vehicle.

The rotating electric machine has a three-phase winding and can be applied to a permanent magnet synchronous motor, a winding field type motor, and an induction machine. The rotating electric machine includes a cylindrical stator 10 shown in FIG. 1 and a rotor (not shown) disposed in a radial inner part of the stator 10 or the like. The rotor is opposed to the stator 10 and is rotatable around a rotation axis. Hereinafter, an axial direction refers to an axial direction of the stator 10, that is, an axial direction of the rotation axis of the rotor. A radial direction refers to a radial direction of the stator 10, that is, a direction passing through a center of the rotation axis of the rotor and orthogonal to the rotation axis. A circumferential direction indicates a circumferential direction of the stator 10, that is, a circulating direction of the rotor around the rotation axis.

As shown in FIGS. 1 and 2, the stator 10 includes a stator core 11 having an annular shape and a stator winding 12 wrapped around the stator core 11. The rotating electric machine of the present disclosure is an inner-rotor type rotary electric machine, in which the rotor is rotatably arranged radially inside of the stator 10. The stator winding 12 is a type of a three-phase winding configured by including a U-phase winding, a V-phase winding, and a W-phase winding as respective phase windings. Among a total range of the stator winding 12, a range overlapping with the stator core 11 in the axial direction serves as a slot inside coil section CS. Among the total range of the stator winding 12, portions located outside of the stator core 11 in the axial direction serve as coil end sections CE1 and CE2, respectively.

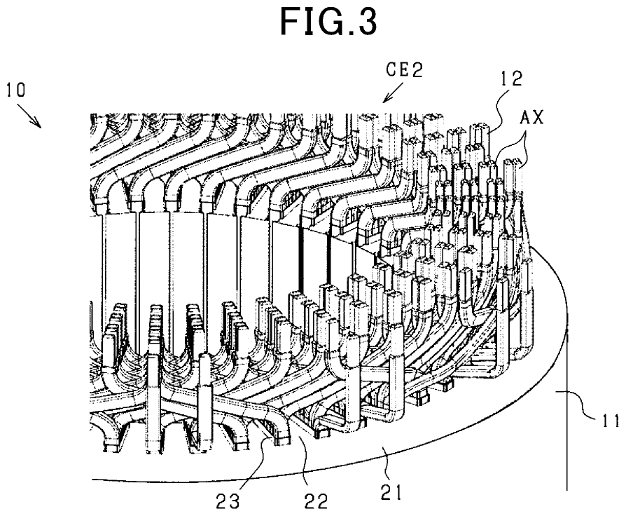

As shown in FIG. 3, the stator core 11 includes an annular back yoke 21 and multiple teeth 22 radially protruding inwardly from the back yoke 21 and arranged apart from each other at a given distance in the circumferential direction. Hence, the stator core 11 includes multiple slots 23 each formed between respective adjacent teeth 22. Each of the slots 23 has an opening with a longitudinal side extended in the radial direction, and is arranged substantially at the same intervals in the circumferential direction in the stator core 11. Then, the stator winding 12 is wrapped around each of the slots 23. The stator core 11 is configured as a core sheet laminate, formed by laminating core sheets, such as electromagnetic steel sheets, etc., in the axial direction to act as a magnetic body.

The stator winding 12 is configured by connecting three-phase windings by a method of Y-letter wire connection (i.e., star-shaped connection). The stator winding 12 generates magnetic fluxes when power (i.e., AC power) is supplied from a power supply via an inverter (not shown). The stator winding 12 is configured by using multiple conductor segments 30 configured by including substantially U-shaped split (i.e., segmented) conductors. Hereinafter, a segment structure of the stator winding 12 will be described in detail.

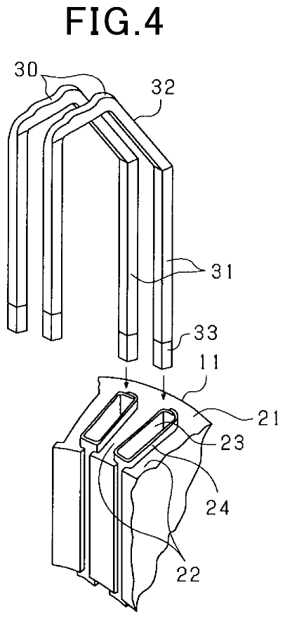

FIG. 4 is a perspective view illustrating the conductor segments 30 (30) and a part of the stator core 11. As shown in FIG. 4, the conductor segment 30 has a pair of linear portions 31 (31) (herein below simply referred to as 31) and a turn portion 32 bent to connect the pair of linear portions 31 to each other, thereby substantially forming a U-shape. Each of the pair of linear portions 31 is longer than an axial thickness of the stator core 11. The conductor segment 30 is configured by using a flat-angle conductor produced by coating a conductor having a rectangular cross section (i.e., a conductor having a pair of opposing planar portions) with an insulating film. A leading end of each of linear portions 31 serves as an exposed portion 33 where the conductor is exposed by removing the insulating film from the linear portion 31.

Then, multiple conductor segments 30 are inserted into given slots 23 of the stator core 11, and are radially aligned therein in a row. In this embodiment, six layers of linear portions 31 of the conductor segments 30 are accommodated in a slot 23 in a lamination state. The pair of linear portions 31 of the conductor segment 30 is housed in given two slots 23 separated at a given coil pitch, respectively. Among the entire portion of the linear portion 31, a portion accommodated in the slot 23 corresponds to a slot inside coil section CS of the stator winding 12. Here, in the slot 23, an insulating sheet 24 is disposed to electrically insulate the stator core 11 from the stator winding 12 (i.e., the conductor segments 30). Specifically, the insulating sheet 24 is disposed in the slot 23 between an inner circumferential surface (i.e., an inner wall surface) of the stator core 11 and the conductor segment 30 and is folded completely to surround multiple conductor segments 30 inserted into the slot 23.

Further, a radial position of one of the pair of linear portions 31 of the conductor segment 30 positioned in the two respective slots 23 is relatively shifted from the other one of the pair of linear portions 31 by an amount of one coil. For example, when one of the linear portions 31 is accommodated at a n-th position counted from a radial back side (i.e., a side of the back yoke), the other one of the linear portions 31 is accommodated at a (n+1)-th position counted from the radial back side.

Further, each conductor segment 30 is inserted into given slots 23 of the stator core 11 as described below. That is, the linear portion 31 of each conductor segment 30 is inserted from a first end of the stator core 11 out of first and second ends respectively located at both ends of the stator core 11 in the axial direction. Then, a leading end of each of the linear portions 31 protrudes from the second end of the stator core 11 in the axial direction. With this, facing the first end of the stator core 11, one of coil ends CE1 is formed by the turn portion 32 of the conductor segment 30. By contrast, at a position axially outside of the second end of the stator core 11, the other one of coil end sections CE2 is formed. That is, in the coil end section CE2, an opposite end (hereinafter simply referred to as a non-turn portion sometimes) of each linear portion 31 opposite to the turn portion 32 is bent in the circumferential direction and connected to a linear portion 31 of another conductor segment 30 as also bent. An outline of each of the above-described coil ends CE1 and CE2 is illustrated in FIG. 2.

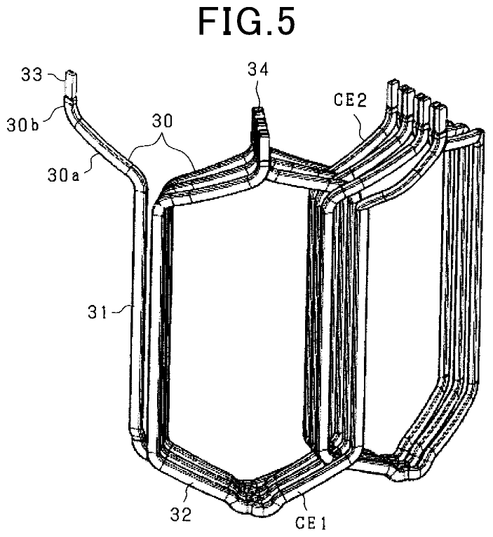

FIG. 5 is a perspective view illustrating a state in which multiple conductor segments 30 are connected to each other. In the conductor segment 30, a portion of each of the linear portions 31 (i.e., an upper end in the drawing) opposite to the turn portion has a crossing portion 30a extended in the circumferential direction. A conducting wire leading end 30b of the conductor segment 30 is bent from the crossing portion 30a and is extended in the axial direction. Then, an exposed portion 33 is provided at the conductor leading end 30b. Further, exposed portions 33 of conductor leading ends 30b of different conductor segments 30 are joined together in the radial direction, and the exposed portions 33 are connected by laser welding. Here, the conductor segment 30 can include two different types of crossing portions 30a at a portion of each linear portion 31 opposite to the turn portion. That is, the first type is that the crossing portion 30a is bent in the same direction as the turn portion 32. The second type is that the crossing portion 30a is bent to a direction opposite to the turn portion 32.

To describe more in detail with reference to FIG. 3, in the coil end section CE2, each of the conductor segments 30 protrudes from the axial end face (i.e., an upper end face in the drawing) of the stator core 11 and is bent in the circumferential direction to be oblique relative to the core end face while forming a given angle therefrom. Then, by mutually joining the exposed portions 33 of the different conductor segments 30 (i.e., conductor leading ends 30b) together by laser welding, multiple conductor segments 30 are connected to each other. Hence, in the coil end section CE2, an axial end AX of the stator winding 12 is formed by connecting the exposed portions 33 to each other. Then, multiple axial ends AXs are similarly formed and arranged to make lines both in the radial and circumferential directions.

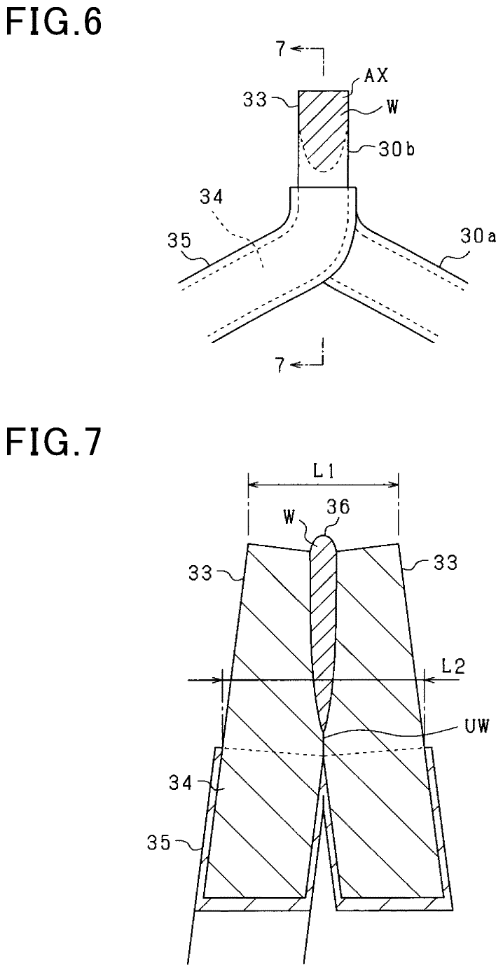

FIG. 6 is a front enlarged view illustrating a configuration of the exposed portion 33 of the conductor segment 30 and the vicinity thereof. As shown, the conductor segment 30 includes a linear conductor 34 and an insulating film 35 covering the conductor 34. A conductor leading end 30b of the conductor 34 is exposed to serve as an exposed portion 33. In each of the conductor segments 30, the crossing portion 30a is extended in the circumferential direction (i.e., left and right directions in the drawing). By contrast, the conductor leading end 30b extended in the axial direction (i.e., a vertical direction in the drawing), and the exposed portions 33 of a different conductor segment 30 are superimposed in the radial direction (i.e., in an orthogonal direction in the drawing) and are connected to each other by welding.

In FIG. 6, W represents a weld produced by melting the conductors 34 of different conductor segment 30. Specifically, laser welding is performed by irradiating a joining portion between exposed portions 33 of different conductor segment 30 with a laser emitted in the axial direction from an opposite side to the core (i.e., from above the joining portion in the drawing). That is, the exposed portions 33 are irradiated with the laser vertically in the drawing. More specifically, the vertical direction in the drawing indicates a laser irradiation direction. In the exposed portion 33, an upper side of the exposed portion 33 in the drawing indicates a laser irradiation incidence side. By contrast, a lower side of the exposed portion 33 in the drawing indicates a side opposite to the laser irradiation incidence side.

In general, in a system in which exposed portions 33, (33) of conductor segments 30 are welded together, it is difficult to confirm a depth of welding in a weld W, that is, a quality of welding, from appearance thereof. Hence, in this embodiment, a depth of welding is determined in accordance with a width of conductors having joined together in a conductor joining direction based on the following two findings. The first is that a degree of melting of a conductor 34 is different in accordance with a depth in a welding direction (i.e., laser irradiation direction) in a weld W. That is, a melting degree is relatively larger at a side receiving laser irradiation (i.e., laser irradiation incidence side), and is relatively smaller at a side opposite thereto. The second is that a width of conductors in a joining direction (i.e., a conductor joining direction), in which the exposed portions 33 are joined together differs in the axial direction due to a difference in melting degree of the conductors 34. Hence, according to this embodiment, the depth of welding can be determined in accordance with the width of the conductors as joined together in a conductor joining direction.

Hereinbelow, an exemplary system of welding a pair of exposed portions 33 of conductor segments 30 will be described more in detail with reference to FIG. 7 and applicable drawings. FIG. 7 is a longitudinal sectional view illustrating each of the exposed portions 33 of the conductor segments 30 across a joining portion thereof. That is, FIG. 7 is a cross-sectional view along a line 7-7 shown in FIG. 6. In FIG. 7, a left and right direction corresponds to a radial direction.

As shown in FIG. 7, at the leading ends of the conductor segments 30, a weld W is located between the exposed portions 33. The weld W is extended from an upper part of each of the exposed portions 33 as a laser irradiation incidence side to a lower part of each of the exposed portions 33 as an opposite side to the irradiation incidence side. In each of the exposed portions 33, the weld W corresponds to a portion in which the conductor 34 is melted during laser welding. By contrast a portion of each of the exposed portions 33 other than the welded portion W is a portion in which the conductor 34 is not melted. Hence, as shown, a non-melting region in the conductor joining direction is relatively small, that is, a melting region is relatively large at the laser irradiation incidence side in the axial direction. By contrast the non-melting region in the conductor joining direction is relatively large at a side opposite to the laser irradiation incidence side. That is, the melting region is relatively small at the opposite side. With this, a collective conductor width in the conductor joining direction is different along the axial direction. That is, a collective conductor width L1 closer to the laser irradiation incidence side is less than a conductor width L2 at a side opposite to the laser irradiation incidence side (L1<L2). That is, based on this configuration, a situation where the collective conductor width L1 at a position closer to the laser irradiation incidence side is less than the collective conductor width L2 at a position opposite to the laser irradiation incidence side indicates that each of the exposed portions 33 has properly melted. Hence, based on a relation between the collective conductor widths L1 and L2 in the exposed portions 33 joined together, it is possible to confirm and determine that laser welding has been appropriately performed.

Between these two exposed portions 33 connected by welding, there is a non-welded portion UW in which non-molten conductors face each other in addition to a presence of the weld W made of molten conductor. Since non-welded portions UWs of the exposed portions 33 are in contact with each other, no gap is formed between these two exposed portions 33. Here, it is preferable that the weld W is produced in the axial direction (i.e., the laser irradiation direction) in a region of more than half of the exposed portion 33. That is, it is preferable that the exposed portions 33 are in contact with each other in a remaining region of the non-welded portion UW.

Further, at a joining boundary on the laser irradiation incidence side of the exposed portions 33 joined together, a rise 36 made of molten conductor is formed. The rise 36 is a bulging part constituted by a surplus conductor and is caused when the conductor width L1 of the laser irradiation incidence side becomes less than the conductor width L2 of a portion opposite to the laser irradiation incidence side in these two exposed portions 33 joined together.

FIG. 8 is a diagram illustrating multiple axial ends AXs aligned radially in the coil end section CE2. As described above, the pair of exposed portions 33 joined together collectively have the conductor width L1 at the laser irradiation incidence side, which is less than the conductor width L2 of the portion opposite to the laser irradiation incidence side. Hence, the axial end AX composed of exposed portions 33 as a set increases a distance between two neighboring axial ends AX in the radial direction, thereby improving an insulation property in the direction.

Further, each of the conductor segments 30 is accommodated in each of slots 23 arranged in the circumferential direction, and is disposed in each of the slots 23 in a multiple layer state radially. In such a situation, when compared with each other, a distance between the axial ends AX in the radial direction is less than a distance between the axial ends AX in the circumferential direction. Hence, each of the axial ends AX aligned in the radial direction may be likely to cause unintentional insulation error.

In view of this, in this embodiment, the exposed portions 33 are joined in (i.e., superposed facing) the radial direction and welded together. Then, the conductor width L1 of the laser irradiation incidence side is less than the conductor width L2 of the portion opposite to the laser irradiation incidence side in the pair of exposed portions 33 joined together. Hence, the distance between the axial ends AX in the radial direction can be more increased when compared with a configuration in which a conductor width L1 of the laser irradiation incidence side is substantially the same as the conductor width L2 of the portion opposite to the laser irradiation incidence side. In particular, in the configuration in which the pair of exposed portions 33 are superimposed in the radial direction and then connected to each other by laser welding like this embodiment, the axial ends AX mutually become closer to each other than in a configuration in which exposed portions 33 are mutually superimposed in the circumferential direction. However, even in such a configuration, favorable insulation can be obtained.

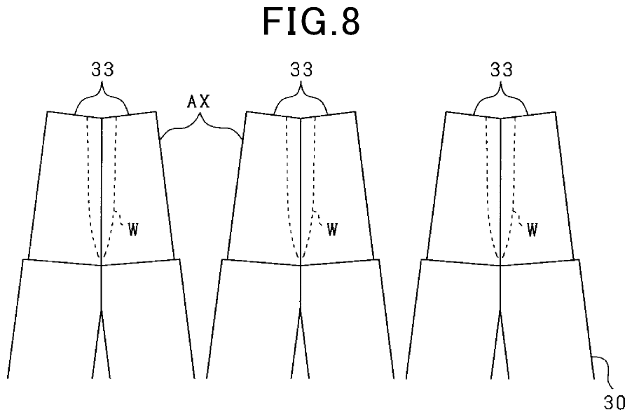

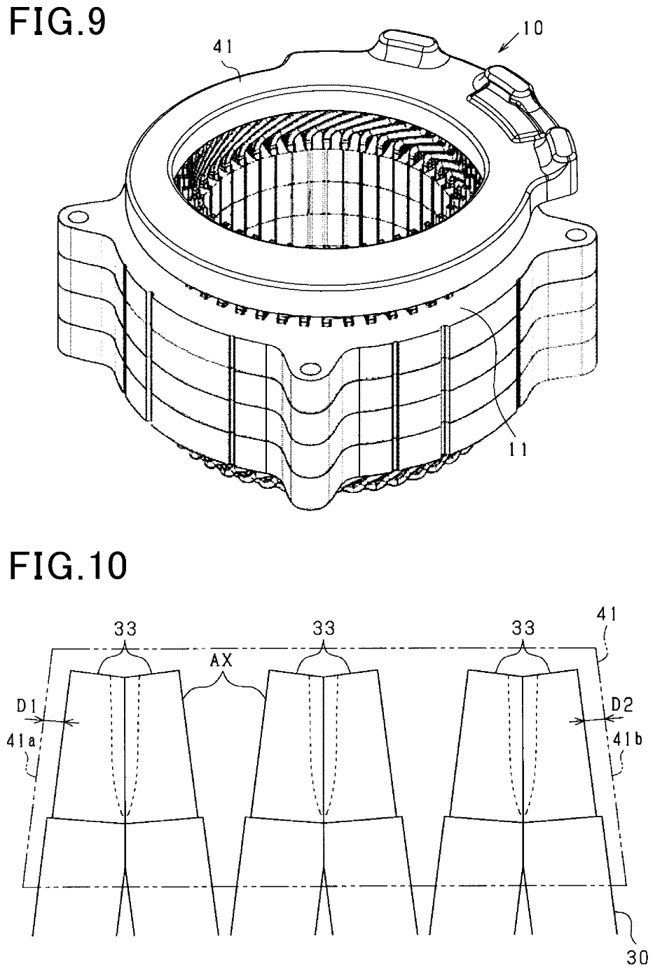

Further, the coil end section CE2 is sealed with insulating resin as shown in FIGS. 9 and 10. Specifically, FIG. 10 shows a state in which the axial ends AX each formed by connecting exposed portions 33 to each other are aligned in the radial direction. At the same time, FIG. 10 illustrates a resin sealer 41 with a virtual wire. As shown in each of the drawings, the coil end section CE2 is provided with an annular resin sealer 41 made of insulating resin.

As shown in FIG. 10, the resin sealer 41 is extended to involve the exposed portions 33 of the conductor segments 30 in the axial direction. That is, an axial region of the resin sealer 41 includes the exposed portions 33 of the conductor segments 30 and is extended up to a position away from the axial end face of the stator core 11. In such a situation, since a region without resin sealing is employed between the resin sealer 41 and the core end face, the region can be used as a coil cooling unit for cooling the stator winding 12. As a cooling system cooling the stator winding 12, a cooling system using cooling oil or cooling water as a refrigerant (e.g., oil cooling, water cooling) and cooling by air cooling may be exemplified.

Here, the resin sealer 41 collectively seals multiple axial ends AX aligned in the radial and circumferential directions, and has a circular shape extended along the axial end face of the stator core 11. 41a and 41b of the resin sealer 41 indicate an inner circumferential surface located radially inside and an outer circumferential surface located radially outside, respectively. Each of these side surfaces 41a and 41b is inclined to the axial direction to approach the axis at an axially outside. An inclination of each of the side surfaces 41a and 41b of the resin sealer 41 corresponds to a gradient used in releasing the sealer 41 from a mold. Then. surfaces of a radially inside most axial end AX and a radially outermost axial end AX of the exposed portions 33, facing the respective side surfaces 41a and 41b of the resin sealer 41 are similarly inclined to the axial direction as the respective side surfaces 41a and 41b.

Here, it is preferable if an angle of inclination of each of the side surfaces 41a and 41b may be equivalent to an angle of inclination of the exposed portions 33, respectively. That is, it is preferable if thicknesses D1 and D2 of insulating resin respectively defined between the radially innermost axial end AX and the side surface 41a, and the radially outermost axial end AX and the side surface 41b of the resin sealer 41 are uniform. With this even if there is a difference in thermal expansion between the conductor 34 and the insulating resin of the resin sealer 41 in accordance with a difference in linear expansion coefficient, a load acting on each of the exposed portion 33 can be equalized.

Further, as described above, between the two exposed portions 33 connected by welding, there is the weld W produced by the molten conductor and the non-welded portion UW in which the nonmolten conductor faces each other. Hence, the insulating resin does not enter a gap between the two exposed portions 33 in each of the axial ends AX. Besides, shearing generally occurs due to a difference in linear expansion coefficient between the conductor and the insulating resin rarely occurs or is inhibited from occurring in the weld W produced between the exposed portions 33.

Next, a method for manufacturing the stator 10 will be hereinbelow described. The manufacturing method roughly includes an assembly step of attaching conductor segments 30 to the stator core 11 and a welding step of welding exposed portions 33 by irradiating a joining portion between exposed portions 33 of the respective conductor segments 30 with laser. The manufacturing method also includes an inspection step of inspecting a welded portion after welding.

In the assembly step, multiple conductor segments 30 are inserted into each of the slots 23 of the stator core 11. Further, at an axial one end, protruding portions of linear portions 31 of the respective conductor segments 30 are bent in the circumferential direction, so that the exposed portions 33 of different conductor segments 30 radially face each other in the radial direction.

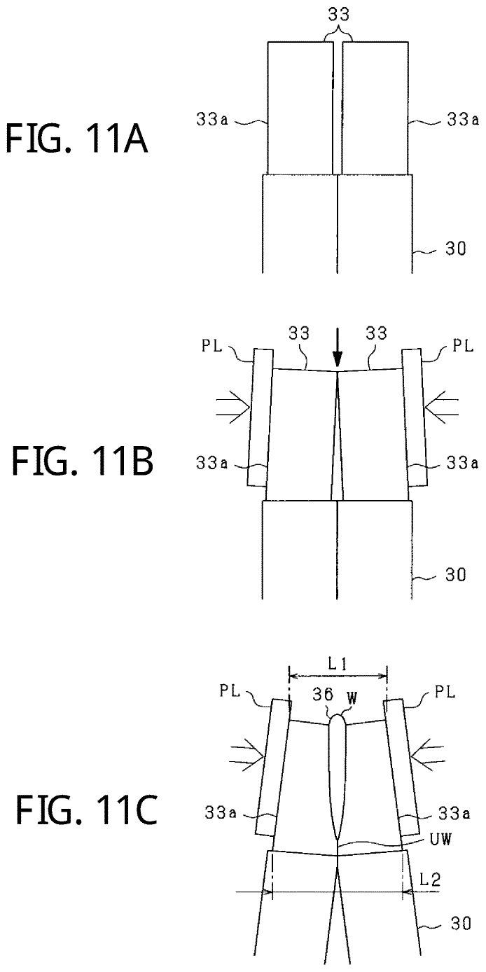

In the welding step, laser welding is performed by irradiating the joining portion between the exposed portions 33 of the different conductor segments 30 as shown in FIGS. 11A to 11C. That is, FIGS. 11A to 11C are diagrams collectively illustrating a change in state of each of the exposed portions 33 when laser welding is performed therein.

As shown in FIG. 11A, the exposed portions 33 of respective conductor segments 30 radially face each other in the radial direction. This shows a state of the exposed portions 33 immediately before welding. Hence, a conductor width in a joining direction (i.e., left and right directions in the drawing) of each of the exposed portions 33, (33) is the same at any position in the axial direction. Hence, in this state, respective side surfaces 33a located opposite to the joining surfaces of the exposure portions 33 are substantially parallel to each other. However, inner opposing surfaces of the exposed portions 33 are separated from each other. However, by expanding a conductor exposure region of the exposure portions 33 inward, the opposing surfaces of the exposed portions 33 can contact each other, for example.

Subsequently, as shown in FIG. 11B, a pair of pressing plates PL are pressed against side surfaces 33a of the two exposed portions 33, respectively, and laser welding is then performed on such a condition. Specifically, at this moment, the joining portion between the exposed portions 33 is irradiated with a laser from an axially outside while the exposed portions 33 are pressure-contacted by the pair of pressing plates PL. With this, the exposed portions 33 melt due to energy of the laser irradiation. A melting region is gradually expanded downward in the axial direction. Further, since the exposed portions 33 are pressure-contacted, the exposed portions 33 mutually come close to each other as the exposed portions 33 melt.

Here, a depth of laser welding, that is, an axial depth of a melt pond produced by accumulation of a molten conductor is correlated with a difference in amount of melt of the conductor between a laser irradiation incidence side and a side opposite to the laser irradiation incidence side. Specifically, the deeper the laser welding depth (i.e., the depth of the melting pond), the greater the melt amount on the laser irradiation incidence side and the greater the difference in melting amount between the laser irradiation incidence side and the side opposite to the laser irradiation incidence side. That is, in accordance with the difference in melting amount between the laser irradiation incidence side and the opposite side thereto, a degree of inclination of the exposed portions 33 to each other changes. As a result, a distance between side surfaces 33a (33a) of the exposed portions 33 opposite to the joining surface changes in each of the exposed portions 33.

Then, as shown in FIG. 11C, when a deepest part of the weld reaches the vicinity of the end of the exposed portion 33, that is, the depth of the weld becomes substantially the same as an axial length of the exposed portion 33, the laser welding is terminated. At this moment, a width L1 of the conductors in the joining direction of the exposed portions 33 at the laser irradiation incidence side is less than a width L2 of the conductor at a side opposite to the laser irradiation incidence side. Here, at a joining boundary where the exposed portions 33 are joined together, there can be a non-welded portion UW in which the nonmolten conductors face each other. However, since the non-welded portion UW of the exposed portions 33 are in contact with each other, and there is no gap between the two exposed portions 33, a given problem is not raised. In each of the conductor segments 30, an insulating film 35 is located near a boundary of the exposed portion 33 and can be melted by heat of the laser. Further, the exposed portions 33 can contact each other. Hence, in the welding step, welding conditions such as laser power may be adjusted in accordance with a ratio between conductor widths L1 and L2 as intended.

Further, during laser welding, the exposed portions 33 are pressure contacted and the laser irradiation incidence side of the exposed portions 33 approach each other. Hence, a molten conductor protrudes from the laser irradiation incidence side to an outside thereof in the axial direction, thereby producing the rise 36.

After completing the laser welding, the weld W produced between the exposed portions 33 is inspected in an inspection step by comparing a conductor width L1 of the laser irradiation incidence side with a conductor width L2 of the opposite side to the laser irradiation incidence side. If the conductor width L1 of the laser irradiation incidence side is less than the conductor width L2 of the opposite side to the laser irradiation incidence side, and a ratio between the conductor widths L1 and L2 falls within a given range, it is determined that a depth of laser welding corresponds to a desired level, and accordingly, each of the exposed portion 33 (33) melts appropriately.

Subsequently, the resin sealer 41 is produced at the coil end section CE2. For example, the coil end section CE2 is immersed in liquidus resin material stored in a sealer molding container. Then, the resin sealer 41 may be molded maintaining the immersed state. As described earlier, since there is no gap between the pair of exposed portions 33, the resin material is inhibited from entering a gap therebetween.

According to the above-described embodiment, the below described advantages can be obtained.

That is, in a system (i.e., configuration) in which the pair of exposed portions 33 are welded together, there is a difference in amount of melting between a laser irradiation incidence side and a side opposite to the laser irradiation incidence side of the pair of exposed portions 33 along the joining surface therebetween in correlation (i.e., accordance) with a depth of laser welding. Then, a conductor width of the exposed portions 33 changes in accordance with a difference in melting amount. In view of this, the depth of the laser welding performed between the exposed portions 33 can be known based on a change in conductor width. For example, in the stator winding 12 of this embodiment, when the exposed portions 33 of the conductor segments 30 are welded together, and a conductor width in a joining direction of a laser irradiation incidence side of the exposed portions 33, which receives an entry of laser irradiation is less than a conductor width of another side opposite to the laser irradiation incidence side, it can be noted therefrom that each of the exposed portions 33 (33) has properly melted. In short, when the conductor width L1 at the laser irradiation incidence side is less than the conductor width L2 at the other side opposite to the laser irradiation incidence side, this means that each of the exposed portion 33 has properly melted. Hence, it is ultimately possible to provide a stator 10 prepared by appropriately performing laser welding.

Further, as described above, in the pair of exposed portions 33 joined together, in addition to that the conductor width L1 at the laser irradiation incidence side is less than the conductor width L2 at the opposite side to the laser irradiation incidence side, a rise 36 made of molten conductor is produced at the laser irradiation incidence side. That is, with the above-described configuration, it is recognized that the rise 36 is formed on the laser irradiation incidence side due to melting of the conductors. That is, it is noted that as melting of the conductors is promoted, the exposed portions 33 approach each other at the laser irradiation incidence side, and accordingly a melted conductor protrudes therefrom. Hence, the rise 36 acts as a sign indicating that each of the exposed portions 33 has melted appropriately. With these, it is possible to recognize a state (i.e., the quality) of welding based on an appearance thereof.

Further, since the conductor width L1 of the laser irradiation incidence side in the joining direction in which the exposed portions 33 join together is less than the conductor width L2 of the side opposite to the laser irradiation incidence side, a distance between the axial ends AXs (i.e., insulation distance) can be more favorably increased when compared to a configuration in which a conductor width L1 of the laser irradiation incidence side has the same as a conductor width L2 of a side opposite to the laser irradiation incidence side. In particular, in a situation where each of exposed portions 33 is superimposed in the radial direction and connected by laser welding, each of axial ends AX generally becomes closer to each other than in a situation where each of exposed portions 33 is superimposed in the circumferential direction. However, according to this embodiment, appropriate insulation can be obtained even with such a former situation.

Further, the coil end section CE2 is provided with the resin sealer 41 made of insulating resin involving the exposed portions 33 extended in the axial direction. With this, a favorable insulation can be maintained between the conductor segments 30.

Further, multiple axial ends AXs of the stator winding 12 are arranged in both radial and circumferential directions in the coil end section CE2, and are collectively sealed in a block by using a resin sealer 41 having a circular shape arranged along the axial end face of the stator core 11. Hence, the resin sealer 41 can be provided appropriately to seal a large number of axial ends AXs at the coil end section CE2. Further, among multiple axial ends AXs arranged in the radial direction, a radially innermost axial end AX and a radially outermost axial end AX have opposing surfaces opposed to inner and outer side surfaces 41a and 41b (i.e., inner circumferential surface and outer circumferential surface) of the resin sealer 41, respectively. Then, these opposing surfaces of the radially inner and outermost axial ends AXs are inclined to substantially the same axial direction as those side surfaces 41a and 41b of the annular sealer 41, respectively. With this, a thickness of insulating resin between the inner peripheral side of the resin sealer 41 and the exposed portion 33 of the innermost, and a thickness of insulating resin between the outer peripheral side of the resin sealer 41 and the exposed portion 33 of the outermost can be uniform. Hence, even if there is a difference in thermal expansion between the conductors and the insulating resin in accordance with a difference in linear expansion coefficient, a load acting on each of the exposed portions 33 can be equalized. With this the stator winding 12 can be favorably protected.

Further, the weld W is produced within a region of half (50%) or more of the exposed portion 33 in the laser irradiation direction, while bringing the non-welded portions UWs of the exposed portions 33 into contact with each other. With this, a highly reliable weld W can be produced.

Further, in a situation where each of exposed portions 33 are sealed with insulating resin at the coil end section CE2, when the insulating resin enters a gap between the pair of exposed portions 33 connected by welding. Due to the difference in linear expansion coefficient between the conductors and the insulating resin, shearing is likely to occur in the weld W generated between the exposed portions 33. However, according to this embodiment, since the non-welded portions UW located between the pair of exposed portions 33 joined together by welding are in contact with each other, the shearing of the weld due to the difference in linear expansion coefficient between the conductors and the insulating resin can be suppressed or avoided.

Further, in the welding process performed during manufacturing of a stator 10, the pair of exposed portions 33 are pressure-contacted, and a joining portion between the exposed portions 33 is irradiated with a laser, so that the conductor width L1 of the laser irradiation incidence side in the conductor joining direction is less than the conductor width L2 of the side opposite to the laser irradiation incidence side. With this a stator 10 manufactured by properly performing laser welding can be obtained.

Further, an inspection step is performed after the laser welding process, in which laser welding is appropriately inspected by comparing a conductor width L1 of a laser irradiation incidence side and a conductor width L2 of a side opposite to the laser irradiation incidence side. Hence, a quality of the weld W can be properly controlled, ultimately.

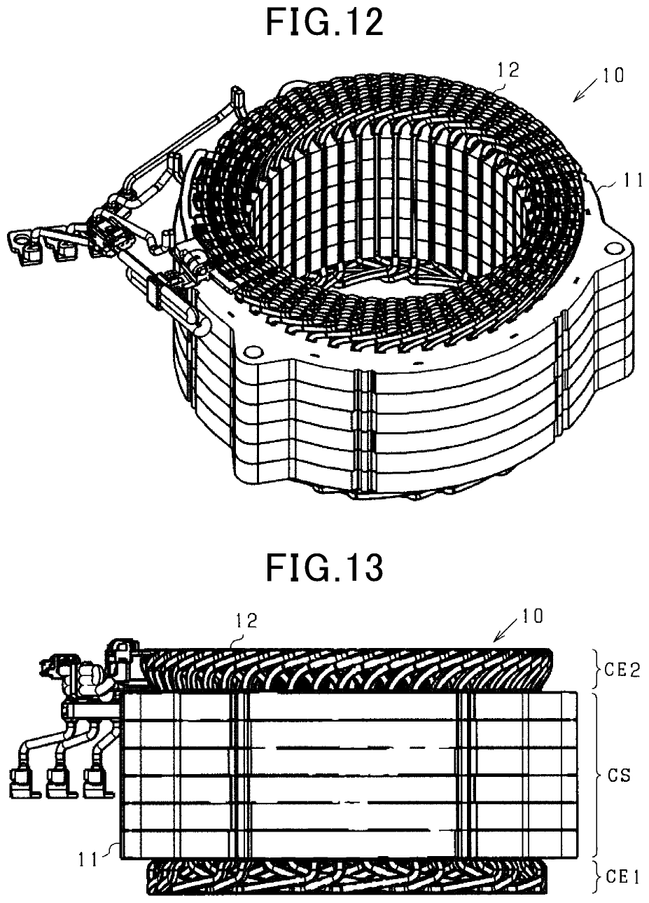

Next, a stator winding 12 according to a second embodiment of the present disclosure will be hereinbelow described with reference to FIG. 12 and applicable drawings. FIG. 12 is a perspective view illustrating a stator 10 according to the second embodiment. FIG. 13 is a front view illustrating the stator 10 of FIG. 12. In the second embodiment, since a configuration of a conductor segment 30 is almost the same as that of the first embodiment shown in FIG. 5, only differences in conductor segment 30 of the first embodiment will be mainly described.

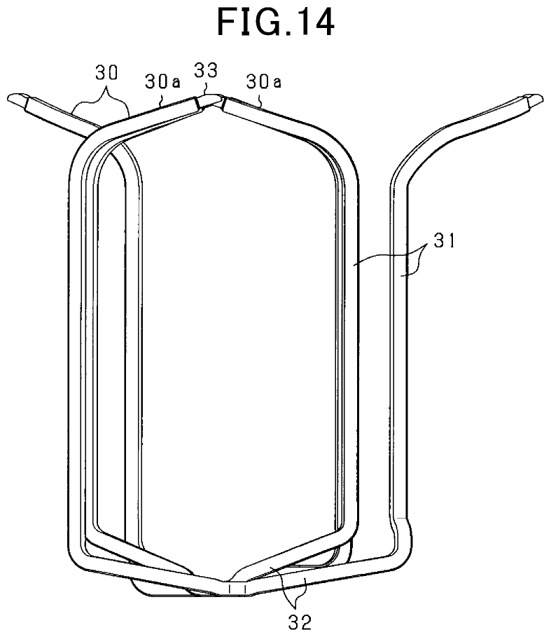

FIG. 14 is a perspective view illustrating a state in which multiple conductor segments 30 are connected to each other. As shown, in a conductor segment 30, portions located opposite to a turn portion of each of linear portions 31 have crossing portions 30a (30a) extended in the circumferential direction. Then, an exposed portion 33 is provided on each of the crossing portions 30a (30a) as a circumferential leading end. Then, a pair of exposed portions 33 of different conductor segments 30 (30) are overlapped in the radial direction with each other, and joined together by laser welding. That is, in the configuration of FIG. 14, unlike the configuration of FIG. 5, the conductor segment 30 of this embodiment does not have a conductor leading end 30b extended in the axial direction. Instead, the exposed portions 33 as the circumferential leading ends of the crossing portion 30a are extended in the circumferential direction and are joined together by laser welding. Hence, the coil end section CE2 is configured by connecting a leading end of a conductor (i.e., a linear portion 31) extended in a given circumferential direction to a leading end of another conductor (i.e., another linear portion 31) extended in a direction opposite to the given circumferential direction.

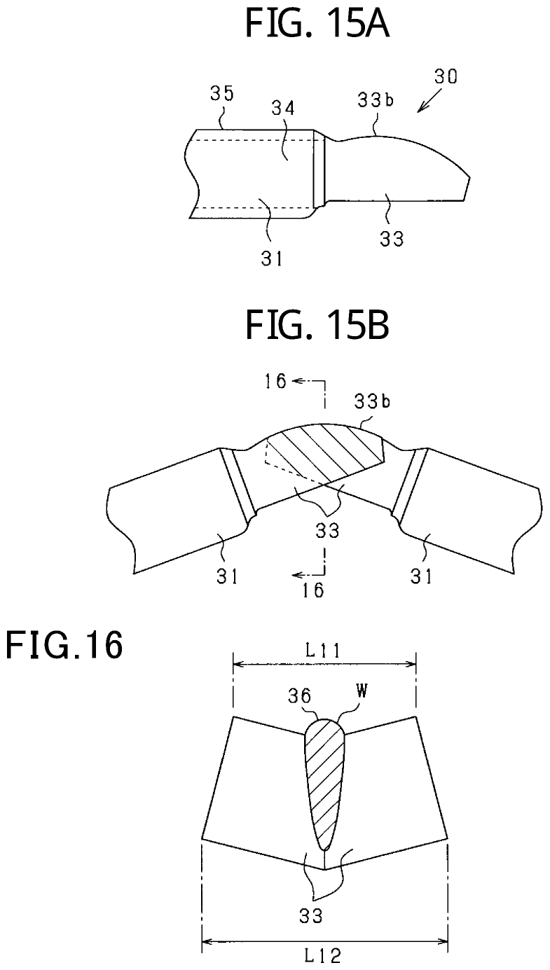

In this embodiment, as shown in FIG. 15A, in the exposed portion 33 of the conductor segment 30, an axial outer surface 33b providing an upper surface in the drawing has an arc shape with a convex portion protruding in the axial direction. Further, each surface of the exposed portion 33 other than the axial outer side 33b, that is, an axial inner side, a radial outer side, and a radial inner side of the conductor exposed portion 33 has flat surfaces, respectively. Then, as shown in FIG. 15B, the exposed portions 33 of the respective conductor segments 30 (30) are superimposed with each other in the radial direction. Then, these the exposed portions 33 are joined together by laser welding maintaining the superimposed state. More specifically, the exposed portions 33 are superimposed with each other with the axial outer surfaces 33b (33b) being substantially coinciding with each other. Then, the laser welding is performed on the axial outer surfaces 33b (33b) (i.e., upper surfaces in the drawing) using laser irradiation. Here, a superimposed portion where the exposed portions 33 face each other has a horizontally longer shape in the circumferential direction than a shape in the axial direction. Hence, during laser welding, laser scanning is performed along the axial outer surface 33b (30b) having an arc-shape within a given range in the circumferential direction.

Hence, as shown in FIG. 16 which is a cross-sectional view along a line 16-16 shown in FIG. 15B, a joining portion where the exposed portions 33 (33) are joined together is irradiated with a laser from above in the drawing, so that the conductors 34 (34) of the exposed portions 33 melt thereby producing a weld W therein. In such a situation, a degree of melting of the conductors 34 (34) is different between a laser irradiation incidence side and a side opposite to the laser irradiation incidence side in the axial direction. That is, a non-melting region in a conductor joining direction is relatively narrow, that is, a melting region is relatively wide at the laser irradiation incidence side in the axial direction. By contrast, the non-melting region in the conductor joining direction is relatively wide at a side opposite to the laser irradiation incidence side. That is, the melting region is relatively narrow at the opposite side. Hence, a conductor width in the conductor joining direction is different along the axial direction. That is, a conductor width L11 of the laser irradiation incidence side is less than a conductor width L12 at a side opposite to the laser irradiation incidence side (i.e., L11<L12). Hence, in such a configuration, a condition in which the conductor width L11 of the laser irradiation incidence side is less than the conductor width L12 at a position opposite to the laser irradiation incidence side indicates that each of the exposed portions 33 (33) has been properly melted. Further, at a joining boundary on the laser irradiation incidence side, where the exposed portions 33 are joined together, a rise 36 made of molten conductor is formed. Hence, with this configuration, it is possible to confirm if laser welding has been appropriately performed.

Further, as a welding process of welding conductor segments 30 (30), laser welding is performed as described below. Here, the welding process is almost similarly performed in the first embodiment as described with reference to FIGS. 11A, 11B, and 11C.

Specifically, the pair of exposed portions 33 are pressure-contacted by a pair of pressing plates PL (see FIGS. 11A, 11B, and 11C), respectively. Then, the joining surface between the exposed portions 33 is irradiated with a laser from a side opposite to the stator core 11, thereby performing laser welding. At this moment, in correlation with a depth of laser welding, a difference in amount of melt occurs between a laser irradiation incidence side and a side opposite to the laser irradiation incidence side along the joining surface. Hence, a collective conductor width of the exposed portions 33 changes in accordance with the melting amount. That is, the conductor width L1 at the laser irradiation incidence side is less than the conductor width L2 at the side opposite to the laser irradiation incidence side.

Here, in a configuration in which respective exposed portions 33 (33) are located at circumferential leading ends of the crossing portions 30a (30a) of the conductor segments 30 (30) extended from opposite side in the circumferential direction, and the circumferential leading ends are joined together by laser welding, it is likely to be more difficult to check a welding depth when compared to a configuration, in which axial leading ends of conductor segments 30 (30) including exposed portions 33 (33) are extended in the axial direction and then the leading ends are joined together by laser welding.

In view of this, according to this embodiment, it can be readily determined that the conductor width L1 at the laser irradiation incidence side is less than the conductor width L2 at the side opposite to the laser irradiation incidence side, and accordingly, the exposed portions 33 (33) are appropriately welded based on this configuration. That is, it can be determined that a depth of laser welding performed between the exposed portions 33 (33) is a given level, and that melting of conductors caused by laser welding is appropriately performed in each of the exposed portions 33.

Further, in each of the above-described embodiments, a part of the configuration may be altered appropriately as described hereinbelow.

First, the stator winding 12 does not necessarily have a segment structure. For example, multiple conducting wires are connected to each other by laser welding to produce each of different phase windings prepared for each phase of the stator winding 12. In such a situation, it is only needed that the conductor width of the pair of exposed portions in the joining direction at the laser irradiation incidence side receiving laser irradiation is less than that at the side opposite to the laser irradiation incidence side.

Secondly, in the above-described embodiments, the resin sealer 41 is provided at the coil end section CE2 of the stator winding 12. However, the resin sealer 41 can be omitted. Numerous additional modifications and variations of the present disclosure are possible in light of the above teachings. It is hence to be understood that within the scope of the appended claims, the present disclosure may be performed otherwise than as specifically described herein. For example, the present disclosure is not limited to the above-described stator and may be altered as appropriate. Further, the present disclosure is not limited to the above-described method of producing a stator and may be altered as appropriate.

What is claimed is:

1. A stator comprising:
a stator core; and
a stator winding provided on the stator core, wherein
the stator winding is formed of a plurality of conducting wires, each of the conducting wires includes a conductor covered with an insulating film, and an exposed portion at a tip end of each of the conducting wires is formed such that the conductor is exposed,
in a coil end portion of the stator winding, a resin sealing portion made of an insulating resin is provided in a region including each exposed portion,
the resin sealing portion has a disk surface extending along an axial end surface of the stator core,
the disk surface is an end surface of the resin sealing portion located on a side axially separated from the stator core,
the resin sealing portion is configured as an annular member having an axial length extending from the disk surface,
the resin sealing portion comprises:
an inner circumferential side surface located radially inward; and
an outer circumferential side surface located radially outward,
each of the inner circumferential side surface and the outer circumferential side surface is inclined with respect to an axial direction in a manner such that the inner circumferential side surface and the outer circumferential side surface approach each other toward an axially outward direction from the stator core,
a surface of radially innermost exposed portion, among exposed portions of the respective conducting wires arranged in a radial direction, facing the inner circumferential side surface, are inclined with respect to the axial direction in the same direction as the inner circumferential side surface of the resin sealing portion and
a surface of radially outer most exposed portion, among exposed portions of the respective conducting wires arranged in a radial direction, facing the outer circumferential side surface, are inclined with respect to the axial direction in the same direction as the outer circumferential side surface of the resin sealing portion.

2. The stator according to claim 1, wherein
the resin sealing portion is formed to integrally seal exposed portions of the respective conducting wires arranged in a radial direction and a circumferential direction.

3. The stator according to claim 1, wherein
the stator winding is provided in slots of the stator core in a state in which the conducting wires are accommodated in multiple radial layers.

4. The stator according to claim 2, wherein
the stator winding is provided in slots of the stator core in a state in which the conducting wires are accommodated in multiple radial layers.

5. The stator according to claim 1, wherein
the coil end portion includes a plurality of axial end portions configured by connecting the exposed portions to each other, and
the plurality of axial end portions are arranged to be aligned in a radial direction and a circumferential direction.

6. The stator according to claim 5, wherein
among the plurality of axial end portions arranged in the radial direction, a radially innermost axial end portion and a radially outermost axial end portion are arranged so as to face the inner circumferential side surface and the outer circumferential side surface of the resin sealing portion, respectively.

7. The stator according to claim 1, wherein
the resin sealing portion is provided to extend in the axial direction to a position separated from the axial end surface of the stator core.

8. The stator according to claim 1, wherein
the inclinations of the inner circumferential side surface and the outer circumferential side surface are formed as draft angles during molding of the resin sealing portion.

9. The stator according to claim 1, wherein
the resin sealing portion is formed in an annular shape over an entire circumference of the coil end portion.
